(19) United States
(12) Patent Application Publication
(10) Pub. No.: US 2022/0164688 A1
(43) Pub. Date: May 26, 2022

(54) SYSTEM AND METHOD FOR AUTOMATED IMPUTATION FOR MULTI-STATE SENSOR DATA AND OUTLIERS

(71) Applicant: Palo Alto Research Center Incorporated, Palo Alto, CA (US)

(72) Inventor: Deokwoo Jung, Mountain View, CA (US)

(73) Assignee: Palo Alto Research Center Incorporated, Palo Alto, CA (US)

(21) Appl. No.: 17/103,536

(22) Filed: Nov. 24, 2020

(51) Int. Cl. G06N 7/00; G06N 20/00

(52) U.S. Cl. CPC G06N 7/005; G06N 20/00

(57) ABSTRACT

A system and method are provided to facilitate automated data imputation. During operation, the system generates a cluster model based on raw data obtained from sensors with multiple states, wherein the raw data includes missing values. The system replaces the missing values with first imputed data based on the cluster model. The system iterates, until a predetermined threshold has been reached, through a series of operations which include: updating the cluster model based on most recently imputed data; predicting outliers based on the cluster model; marking the outliers as null values to obtain filtered data; updating the cluster model based on the filtered data; and replacing the null values with second imputed data based on the cluster model.

### FIELD

This disclosure is generally related to the field of data analysis. More specifically, this disclosure is related to a system and method which facilitates automated imputation for multi-state sensor data and outliers.

### RELATED ART

In many Industrial Internet of Things (IoT) applications, a large volume of high-dimensional data may be continuously collected from heterogeneous sensors for various applications, e.g., planning, prognostics, and diagnostics. Sensor data can be lost and corrupted during the data collection due to sensor malfunctions, unreliable communication channels, and unstable databases. As the number of sensors (i.e., attributes) increases, so increases the chance of corrupted/missing data per database query. This in turn can result in rapidly compromised data quality for machine learning algorithms.

For example, when a feature matrix is constructed for a multivariate analysis algorithm, a significant number of samples or attributes may be discarded due to issues relating to data quality. A simplistic and naïve approach can be to eliminate samples which contain null data points or features with poor data quality (e.g., missing data). However, this elimination can result in a large waste of collected sensor data if the data loss or corruption randomly occurs across the feature matrix. One solution to address this data waste is to perform data imputation, by replacing the missing data with substituted values.

One challenge of data imputation is to avoid introducing unwanted data artifacts. In particular, it can be difficult to perform data imputation for multi-dimensional data with unknown multi-states and outliers, which may occur in sensor data for many industrial applications. For example, multi-dimensional data from industrial sensors can include both null values and outliers. For a large-scale Industrial IoT application, e.g., with high-dimensional and multi-state sensor data, the challenge remains to automate the preprocessing of the data (including outlier elimination and missing-data imputation).

### SUMMARY

A system and method are provided to facilitate automated data imputation. During operation, the system generates a cluster model based on raw data obtained from sensors with multiple states, wherein the raw data includes missing values. The system replaces the missing values with first imputed data based on the cluster model. The system iterates, until a predetermined threshold has been reached, through a series of operations which include: updating the cluster model based on most recently imputed data; predicting outliers based on the cluster model; marking the outliers as null values to obtain filtered data; updating the cluster model based on the filtered data; and replacing the null values with second imputed data based on the cluster model.

In some embodiments, prior to generating the cluster model based on the raw data, the system: receives a request to process the raw data, wherein a state of a sensor includes one or more of off, idle, and active; subsequent to iterating through the series of operations until the predetermined threshold has been reached, returns final data generated based on the cluster model; and stores, in a database, the final data as preprocessed data.

In some embodiments, generating the cluster model based on the raw data, replacing the missing values with the first imputed data, updating the cluster model based on the filtered data, and replacing the null values with the second imputed data is performed by a first module. Updating the cluster model based on the most recently imputed data, predicting the outliers, and marking the outliers as null values is performed by a second module.

In some embodiments, iterating through the series of operations further involves the first module: receiving, as input data, the raw data or the filtered data; replacing the missing or null values with the most recently imputed data; and transmitting, as output data, the most recently imputed data to the second module.

In some embodiments, iterating through the series of operations further involves the second module: receiving, as input data, the most recently imputed data from the first module; updating the cluster model based on the most recently imputed data; predicting the outliers based on the cluster model; removing the outliers by marking the outliers as null values to obtain the filtered data; and transmitting, as output data, the filtered data to the first module.

In some embodiments, the first module includes a first cluster outlier module, a resampler module, and a denormalizer module. The second module includes a second cluster outlier module and a null value imputer module.

In some embodiments, generating the cluster model based on the raw data and updating the cluster model based on the most recently imputed data or the filtered data comprises one or more of: determining, based on the raw data, the most recently imputed data, or the filtered data, clusters and information associated with the clusters, wherein the information associated with the clusters includes one or more of: a number of clusters; a centroid of a respective cluster; and a standard deviation associated with the respective cluster; classifying a cluster as an outlier cluster; classifying a point as an outlier point; and determining that the outlier point belongs to a first cluster of the determined clusters.

In some embodiments, replacing the missing values with the first imputed data and replacing the null values with the second imputed data comprises: generating, for a missing or null value based on a Gaussian distribution, a sample based on the determined clusters and the information associated with the clusters; and replacing the missing or null value with the generated sample.

In some embodiments, the cluster model is generated or updated based on a Gaussian Mixture Model with a number of centroids. A probability density function of the GMM is based on a Gaussian distribution. An outlier cluster is defined based on a user-defined threshold. An outlier point is defined based on a user-defined confidence level.

### BRIEF DESCRIPTION OF THE FIGURES

FIG. 1 illustrates an exemplary environment for facilitating automated data imputation, in accordance with an embodiment of the present application.

FIG. 2 illustrates an exemplary architecture with a cluster imputer module and an outlier removal module, including iterations between the two modules, in accordance with an embodiment of the present application.

FIG. 3A illustrates an exemplary diagram with clusters, outlier points, and an outlier cluster, in accordance with an embodiment of the present application.

FIG. 3B illustrates a table with exemplary data, which can correspond to the diagram of FIG. 3A, in accordance with an embodiment of the present application.

FIG. 4 illustrates an exemplary cluster outlier module corresponding to FIG. 2, in accordance with an embodiment of the present application.

FIG. 5 depicts an exemplary environment for facilitating automated data imputation, in accordance with an embodiment of the present application.

FIG. 6 presents a flow chart illustrating a method for facilitating automated data imputation, in accordance with an embodiment of the present application.

FIG. 7A presents a flow chart illustrating a method for facilitating automated data imputation, in accordance with an embodiment of the present application.

FIG. 7B presents a flow chart illustrating a method for facilitating automated data imputation, in accordance with an embodiment of the present application.

FIG. 8 illustrates an exemplary distributed computer and communication system that facilitates automated data imputation, in accordance with an embodiment of the present application.

FIG. 9A illustrates an exemplary display screen with interactive graphical user interface elements, in accordance with an embodiment of the present application.

FIG. 9B illustrates an exemplary display screen with interactive graphical user interface elements, in accordance with an embodiment of the present application.

FIG. 9C illustrates an exemplary display screen with interactive graphical user interface elements, in accordance with an embodiment of the present application.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

The embodiments described herein provide a system which facilitates automated data imputation for multi-state sensor data with outliers, using an iterative feedback loop which updates a learned model by replacing missing or null values with resampled data.

As described above, in many IoT applications, a large volume of high-dimensional data may be continuously collected from heterogeneous sensors for various applications, e.g., planning, prognostics, and diagnostics. Sensor data can be lost and corrupted during the data collection due to sensor malfunctions, unreliable communication channels, and unstable databases. As the number of sensors (i.e., attributes) increases, so increases the chance of corrupted/missing data per database query. This in turn can result in rapidly compromised data quality for machine learning algorithms.

For example, when a feature matrix is constructed for a multivariate analysis algorithm, a significant number of samples or attributes may be discarded due to issues relating to data quality. A simplistic and naïve approach can be to eliminate samples which contain null data points or features with poor data quality (e.g., missing data). However, this elimination can result in a large waste of collected sensor data if the data loss or corruption randomly occurs across the feature matrix. One solution to address this data waste is to perform data imputation, by replacing the missing data with substituted values.

One challenge of data imputation is to avoid introducing unwanted data artifacts. In particular, it can be difficult to perform data imputation for multi-dimensional data with unknown multi-states and outliers, which may occur in sensor data for many industrial applications. For example, vibration sensors can be attached to equipment that measures a Root Mean Square (RMS) value of three-axis acceleration. Note that equipment can often operate with multiple states (e.g., off, idle, and active) of which emits their distinctive vibration signals. Thus, three-axis sensor measurements can follow a three-dimensional (3D) Gaussian distribution given a hidden state of a unit of equipment under monitoring. Multi-dimensional data from such industrial sensors can include both null values and outliers. For a large-scale Industrial IoT application, e.g., with high-dimensional and multi-state sensor data, the challenge remains to automate the preprocessing of the data (including outlier elimination and missing-data imputation).

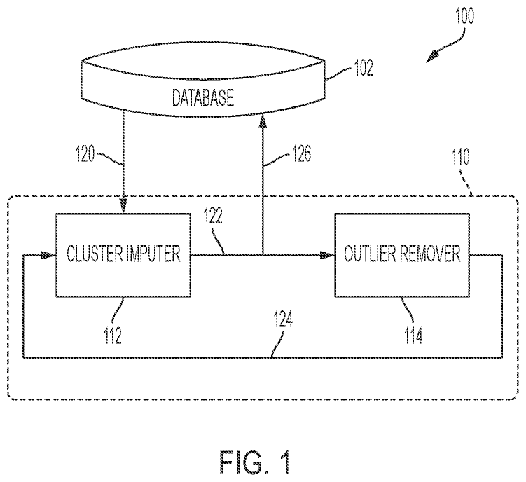

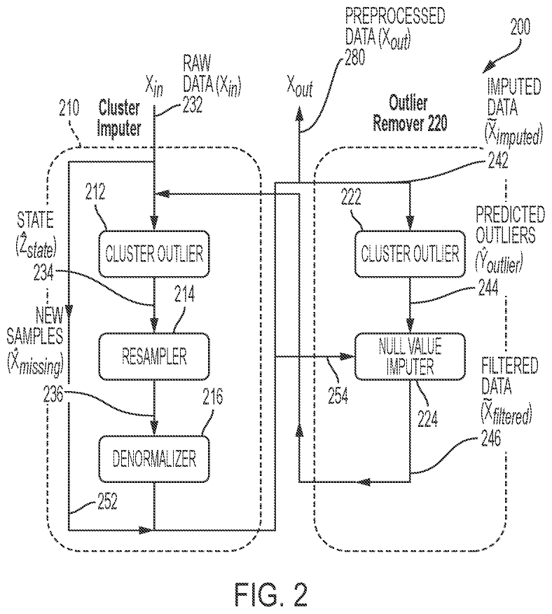

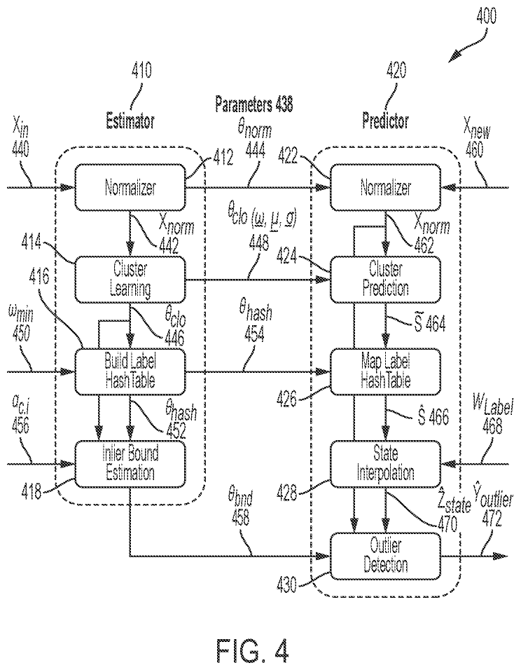

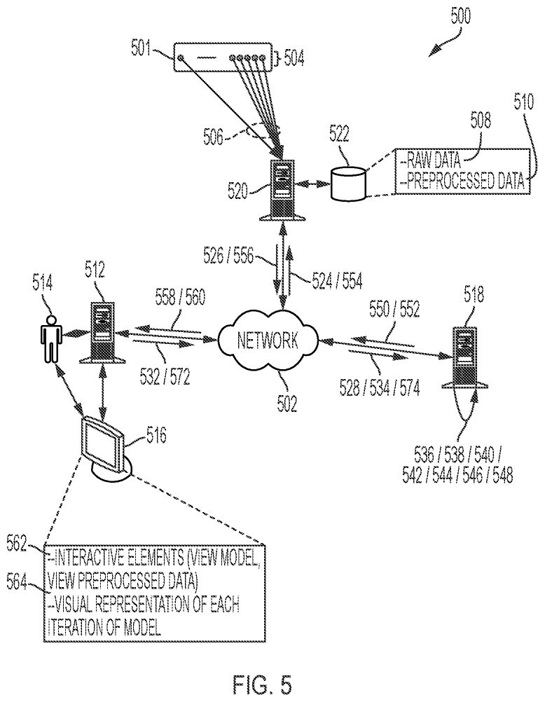

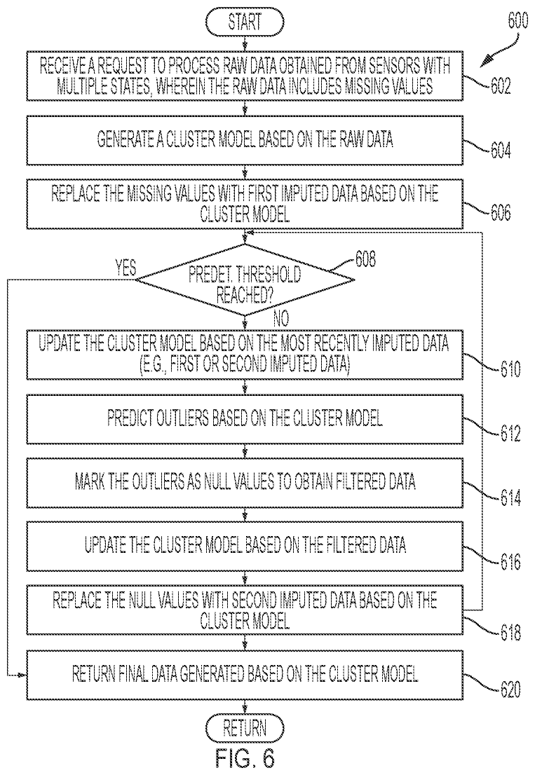

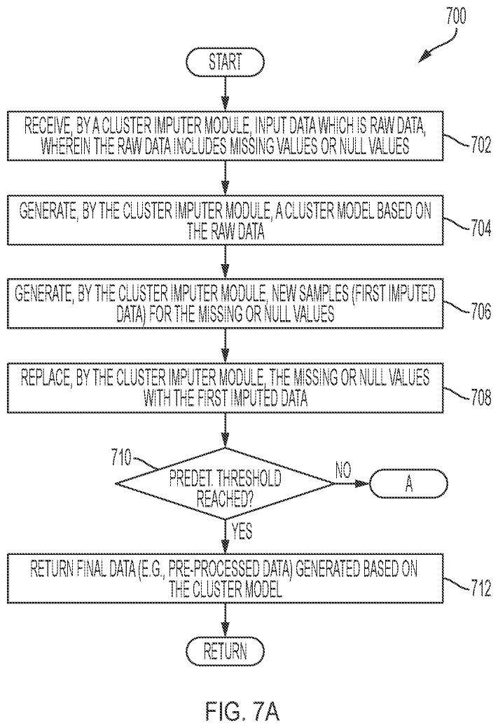

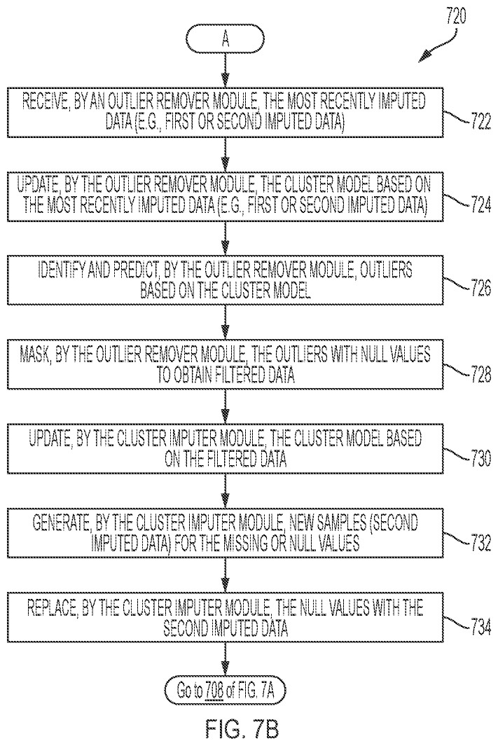

The embodiments described herein provide a system which facilitates automated data imputation for high-dimensional, multi-state sensor data with outliers. The system can perform operations in a feedback loop, by iterating through imputing data for missing values and identifying/eliminating outliers. For example, the system can learn a cluster model based on incoming raw data, resample missing values from the learned cluster model, and impute the missing values with the resampled data to obtain imputed data. The system can subsequently relearn the cluster model based on the imputed data, identify outliers from the learned cluster model, and eliminate the predicted outliers, to obtain filtered data. The system can loop back and repeat these operations, e.g., by relearning the cluster model based on the filtered data, etc. The system can iterate through these operations until a certain predetermined threshold is reached or other stopping criteria is met. The system can return final data back as preprocessed data, e.g., in response to a request for preprocessed data or to be stored in a database as preprocessed data for subsequent usage. An exemplary high-level system environment is described below in relation to FIGS. 1 and 5. A detailed system, including a cluster imputer module and an outlier remover module, is described below in relation to FIG. 2, and an exemplary cluster outlier module is described below in relation to FIG. 4. Exemplary methods for facilitating automated data imputation are described below in relation to FIGS. 6, 7A, and 7B.

Thus, by automating the process of data imputation in a matrix based on data obtained from multi-state sensors, the described embodiments provide a system which can address the challenge of preprocessing a large amount of multi-state sensor data (which multiple states cannot be observed directly by human eyes). The system can perform an automated process which iterates, in a feedback loop, through imputing data by replacing missing or null values with resampled data based on a learned cluster model, and eliminating outliers based on an updated cluster model, until a certain predetermined threshold is reached. The end result can be a matrix for the multi-state sensor data, where the matrix does not include any missing or null values or outliers. This allows the system to retain the valid data, rather than discarding valid data for a particular timestamp based on invalid, missing, null, or outlier values, as in the prior art.

The described embodiments of an overall system for automated data imputation include modules, components, or units which can interact in an iterative feedback loop, to provide a solution to problem of data imputation for multi-state sensor data and outliers, including obtaining, storing, processing, and managing data to obtain preprocessed data, and subsequently using the preprocessed data in various technical applications. Thus, the disclosed system is directed to a solution which is both necessarily rooted in computer technology and provides a specific implementation of a solution to a problem in the software arts.

Furthermore, the described embodiments may be integrated into many different practical applications, i.e., used in many technical fields and for many different applications. For example, the described embodiments may be integrated into applications related to industrial Internet of Things, which can include interconnected sensors, instruments, and other physical devices networked together with industrial applications on various computing device, including in the technical fields of manufacturing and energy management. Thus, the improvements provide by the disclosed system apply to several technologies and technical fields, including but not limited to: industrial IoT applications; machine data analytics; outlier removal; data imputation; and data mining of voluminous and error-prone sensor data.

The term “autoimputer” refers to the described embodiments of the overall system, which includes a cluster imputer and an outlier remover, and performs the functions described herein.

The terms “cluster imputer” and “cluster imputer module” are used interchangeably in this disclosure, and refer to a component or unit of the overall system which learns the cluster model and replaces missing or null values with resampled values, as described below in relation to FIGS. 1, 2, and 4.

The terms “outlier remover” and “outlier remover module” are used interchangeably in this disclosure, and refer to a component or unit of the overall system which relearns or updates the cluster model based on imputed data, predicts outliers, and removes outliers by marking them as missing or null values, as described below in relation to FIGS. 1, 2, and 4.

The terms “cluster outlier” and “cluster outlier module” are used interchangeably in this disclosure, and refer to a component or unit of the cluster imputer and the outlier remover modules, and is described below in relation to FIGS. 2 and 4.

The terms “estimator” and “estimator module” are used interchangeably in this disclosure, and refer to a module in a cluster outlier which performs the operations described below in relation to FIG. 4. The terms “predictor” and “predictor module” are used interchangeably in this disclosure, and refer to a module in a cluster outlier which performs the operations described below in relation to FIG. 4.

The terms “regenerate,” “relearn,” and “update” the cluster model are used interchangeably in this disclosure, and refer to updating a previously-generated cluster model based on imputed data, most recently imputed data, filtered data, updated data, or data that has been modified from data which was used to construct the previously-generated cluster model.

### Exemplary Environment: AutoImputer

FIG. 1 illustrates an exemplary environment 100 for facilitating automated data imputation, in accordance with an embodiment of the present application. Environment 100 can include: a database 102; and an autoimputer 110. Autoimputer 110 can include a cluster imputer 112 and an outlier remover 114. During operation, cluster imputer 112 can receive raw data (Xᵢₙ) 120 from database 102. Cluster imputer 112 can learn a cluster model based on raw data 120 (Xᵢₙ), resample missing values from the learned cluster model, and impute the missing values with the resampled values, to obtain imputed data. Cluster imputer 112 can send the imputed data (via a communication 122) to outlier remover 114.

Outlier remover 114 can receive the imputed data (via communication 122), relearn the cluster model based on the imputed data, identify or predict outliers from the learned cluster model, and eliminate the identified or predicted outliers, to obtain filtered data (X_{filtered}) 124. Outlier remover 114 can send filtered data (X_{filtered}) 124 back to cluster imputer 112.

Cluster imputer 112 can update the current cluster model based on filtered data (X_{filtered}) 124, resample missing values from the current cluster model, and impute the missing values with the resampled values, to obtain imputed data. The system can determine whether a certain predetermined threshold or predetermined stopping criteria has been reached or met. If it has, the system can return preprocessed data (Xₒᵤₜ) 126 to database 102. If it has not, the system can iterate through the above operations, i.e., through outlier remover 114 and back to cluster imputer 112, as described above.

### Algorithm and Exemplary Architecture: Cluster Imputer and Outlier Remover Modules

For a formal description of an exemplary algorithm, the following simplified matrix notations can be used. For an n×m matrix A=[aᵢⱼ]ₙₘ, an ith row vector and a jth column vector are denoted by A_{i.} and A_{.j} where 1≤i≤n and 1≤j≤m. Assume that a p feature sensor with n samples each can represent certain unknown states of a system of interest. In addition, assume that all sensor data is normalized to have a zero-mean and unit-variance after data preprocessing. Let Xₙₒᵣₘ denote the normalized feature matrix defined by X=[xᵢⱼ]ₙₚ, where xᵢⱼ is the ith sample of the pth feature sensor for 1≤i≤n and 1≤j≤p. The column vector X_{.j}=[x₁ⱼ, . . . , xₙⱼ] is data from feature sensor j. A vector or an array of x is denoted by x=(x₁, . . . , xₚ).

FIG. 2 illustrates an exemplary architecture 200 with a cluster imputer module 210 and an outlier removal module 220, including iterations between the two modules, in accordance with an embodiment of the present application. Cluster imputer module 210 can include: a first cluster outlier module 212; a resampler module 214; and a denormalizer module 216. Outlier remover module 220 can include: a second cluster outlier module 222; and a null value imputer module 224. During operation, cluster outlier 212 can receive raw data (Xᵢₙ) 232 and generate a cluster model based on raw data (Xᵢₙ) 232. Cluster outlier 212 can learn model parameters (i.e., generate the cluster model) and predict hidden states (\hat{Z}ₛₜₐₜₑ) 234 for raw data (Xᵢₙ) 232, and pass hidden states (\hat{Z}ₛₜₐₜₑ) 234 to resampler 214. Resampler 214 can identify missing values, generate new samples (\hat{X}_{missing}) 236, and impute new samples (\hat{X}_{missing}) 236 to raw data (Xᵢₙ) 232, which results in constructing a null value-free matrix of imputed data (\tilde{X}_{imputed}) 242. Denormalizer 216 can denormalize new samples (\hat{X}_{missing}) 236, and can pass imputed data (\tilde{X}_{imputed}) 242 to outlier remover module 220. Note that cluster imputer 210 can also normalize raw data (Xᵢₙ) 232 as part of the operations performed by cluster outlier 212 (not shown), and that denormalizer 216 can perform the reverse operation when sending imputed data (\tilde{X}_{imputed}) 242 to outlier remover 220.

Outlier remover 220 can receive, by cluster outlier 222, imputed data (\tilde{X}_{imputed}) 242. Cluster outlier 222 can relearn or update the cluster model based on imputed data (\tilde{X}_{imputed}) 242. Cluster outlier 222 can also generate predicted outliers (Ŷₒᵤₜₗᵢₑᵣ) 244, as an outlier label where a value of −1 indicates an outlier sample, and a value of +1 indicates an inlier sample. Cluster outlier 222 can transmit (Ŷₒᵤₜₗᵢₑᵣ) 244 (e.g., as predicted outliers 244) to null value imputer 224, which can mask the detected outlier samples with a null value. This can result in generating outlier-filtered data to null value-corrupted data of filtered data (\tilde{X}_{filtered}) 246. Outlier remover 220 can subsequently send filtered data (\tilde{X}_{filtered}) 246 back to cluster imputer 210.

The system depicted in architecture 200 can iterate through the above-described operations until a predetermined threshold has been reached or until a predetermined stopping criteria has been met. When the predetermined threshold or stopping criteria is detected, the system can return final data generated based on the current cluster model as preprocessed data (Xₒᵤₜ) 280, which is obtained based on imputed data (\tilde{X}_{imputed}) 242 through the iterations.

Detailed Description of Cluster Outlier Module and Exemplary Diagram with Clusters, Outlier Points, and Outlier Cluster

The cluster outlier module (e.g., cluster outlier 212 and cluster outlier 222 of FIG. 2) can learn a column-wise model independently in parallel, where each column (i.e., sensor) can be modeled as a univariate Gaussian Mixture Model (GMM) with a number of K centroids. The probability density function of GMM with K centroids can be written by:

$$p ( x ) = {\sum }_{1 \leq k \leq K} {w}_{k} N ( x \vert {u}_{k} , {σ}_{k} ) \qquad Equation ( 1 )$$

where 0≤wₖ≤1 is the weight probability with Σₖ wₖ=1 and N(x|uₖ, σₖ) is a Gaussian distribution of the random variable x with a mean uₖ and standard deviation σₖ of cluster k. An outlier can be defined by outlier clusters whose weight probability wₖ is less than a user-defined threshold wₘᵢₙ and outlier points which are outside the confidence interval (xₖ^{l}, xₖ^{u}) given a user-provided confidence level α_{c.i} such that N(xₖ^{l}≤x≤xₖ^{u}|uₖ, σₖ)≤α_{c.i}.

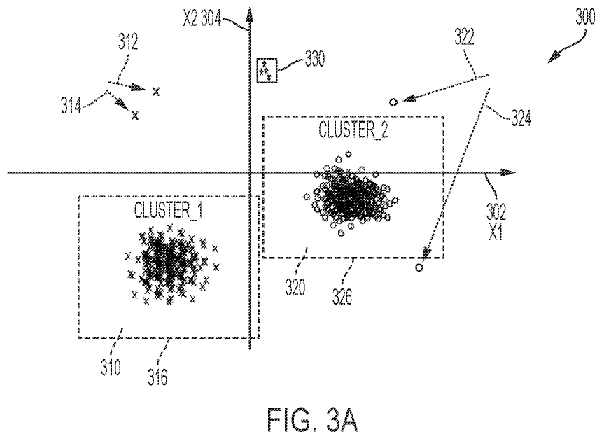

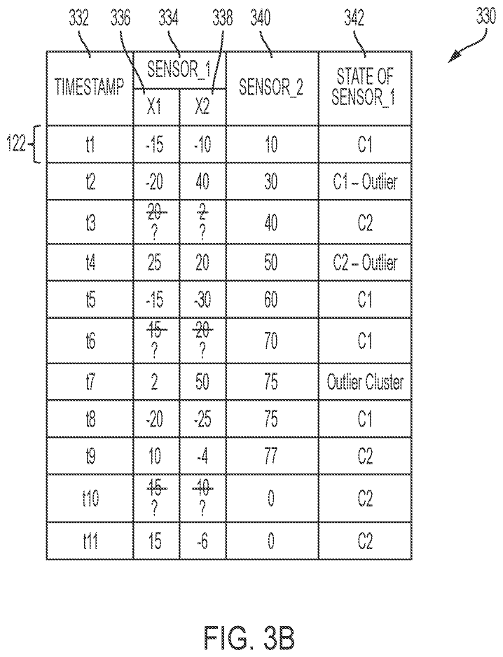

FIG. 3A illustrates an exemplary diagram 300 with clusters, outlier points, and an outlier cluster, in accordance with an embodiment of the present application. Diagram 300 can include: a cluster_1 310 with associated inline bounds 316; a cluster_2 320 with associated inline bounds 326; a point outlier 312 (of cluster_1 310); a point outlier 314 (of cluster_1 310); a point outlier 322 (of cluster_2 320); a point outlier 324 (of cluster_2 320); and an outlier cluster 330. Diagram 300 indicates that the system has determined two major cluster (cluster_1 310 and cluster_2 320) and one minor cluster (outlier cluster 330). Outlier cluster 330 is classified as an outlier cluster because its weight (i.e., the probability of occurrence) is below wₘᵢₙ. The two points close to cluster_1 310 but which fall outside of inline bounds 316 are classified as point outliers or outlier points 312 and 314 of cluster_1 310. Similarly, the two points close to cluster_2 320 but which fall outside of inline bounds 326 are classified as point outliers or outlier points 322 and 324 of cluster_2.

FIG. 3B illustrates a table 330 with exemplary data, which can correspond to the diagram of FIG. 3A, in accordance with an embodiment of the present application. Table 330 can include rows which include data from multiple sensors at various times (e.g., associated with different and sequential timestamps). Each row can include: a timestamp 332; data X1 336 and data X2 obtained from a sensor_1 334; data obtained from a sensor_2 336; and a state of sensor_1 342. The system can classify the obtained data by learning or generating a cluster model. The model can result in classifying, as the state of sensor_1, the data at time t1 as belonging to cluster C1 (e.g., cluster_1 310). The model can classify the data at time t2 as a point outlier of cluster_1 310 (e.g., point outlier 312). The model can classify the data at time t4 as a point outlier of cluster C2 (e.g., point outlier 322 of cluster_2 320). The model can classify the data at time t5 as belonging to cluster C1 (e.g., cluster_1 310). The model can classify the data at time t7 as belonging to an outlier cluster (e.g., outlier cluster 330). The model can classify the data at time t8 as belonging to cluster C1 (e.g., cluster_1 310). The model can classify the data at time t9 and time t11 as belonging to cluster C2 (e.g., cluster_2 320).

The system can determine that the data at times t3, t6, and t10 contain missing or null values (“lost data”). As discussed above, a naïve approach is to discard the entirety of the data for the data at times t3, t6, and t10. However, this would result in discarding valid data, and would be a waste of the obtained valid data (e.g., for sensor_2 340). Because the system has already generated the cluster model, the system can replace the lost data with representative data (i.e., imputed data or resampled data) based on the Gaussian distribution.

The system can subsequently update the cluster model based on the imputed data, identify the outliers, and remove the outliers by replacing the outliers with null values (as described above in relation to FIG. 2) to obtain filtered data. The system can iterate through updating the cluster model based on this filtered data, replacing missing or null values with representative samples (imputed data), updating the cluster model based on the imputed data, removing outliers by replacing with null values, etc., until a certain predetermined threshold has been reached. That is, the system can replace missing or null values with representative samples (e.g., for the lost data at times t3, t6, and t10), and then discard the outliers and replace with representative samples, until a feature matrix is obtained which includes no missing values and no outliers. The stopping criteria is thus based on a convergence to a single feature matrix which does not include any missing values or outliers.

### Exemplary Cluster Outlier Module: Estimator and Predictor Modules

FIG. 4 illustrates an exemplary cluster outlier module 400 corresponding to FIG. 2, in accordance with an embodiment of the present application. Cluster outlier module 400 can include an estimator module 410 and a predictor module 420. Estimator 410 can include: a normalizer module 412; a cluster learning module 414; a build label hashtable module 416; and an inlier bound estimation 418. Predictor 420 can include: a normalizer module 422; a cluster prediction module 424; a map label hash table 426; a state interpolation module 428; and an outlier detection module 430. Estimator 410 can generate parameters 438 which are used by predictor 420, as described below.

Estimator 410, by normalizer module 412, takes as input data Xᵢₙ 440, and normalizes or transforms Xᵢₙ 440 to Xₙₒᵣₘ 442, which can have a zero mean and a unit variance for each column which can produce normalizer parameter θₙₒᵣₘ 444. Cluster learning module 414 can take Xₙₒᵣₘ 442 and estimate the optimal number of clusters and density distribution of each cluster, which produces a parameter tuple of clusters θ_{clo} 446, wherein θ_{clo}=(w, u, σ) for each column such that w=(w₁, . . . , w_{K}_{ᵢ}) for the ith column, e.g., a fitted cluster model (mean shift object).

Next, build label hashtable module 416 can take θ_{clo} 446 and build a label hash table for all clusters, such that wₖ<wₘᵢₙ is assigned to an outlier cluster labeled by −1 and other valid clusters are reassigned to a new unique label. Build label hashtable module 416 can store the label reassignment in the label hashtable as hash table parameter θₕₐₛₕ. Inlier bound estimation module 418 can compute the inlier bound of a normalized column for each cluster based on θ_{clo} 446 (fitted cluster model) and α_{c.i} 456 (user-defined confidence level), which results in producing θ_{bound} 458 for all columns. Thus, estimator 410 can produce a set of parameters θₚₐᵣₐₘ=(θₙₒᵣₘ, θ_{clo}, θₕₐₛₕ, θ_{bound}) which are learned from input data Xᵢₙ 440 and user-defined control parameters wₘᵢₙ 450 and α_{c.i} 456. The system can use a MeanShift Clustering Algorithm for cluster learning by default which empirically shows the best performance for multi-state sensor data when the number of clusters is not provided.

Predictor 420 can use the leaned parameter θₚₐᵣₐₘ for each step, as depicted in FIG. 4 (e.g., parameters 438, including 444, 4487, 454, and 458). Normalizer module 422 can take as input data θₙₒᵣₘ 444 and/or X_{new} 460, and can normalize or transform X_{new} 460 or θₙₒᵣₘ 444 into Xₙₒᵣₘ 462. Cluster prediction module 424 can detect a cluster label \tilde{S} 464 (i.e., sensor state) independently in parallel for each column. Next, map label hashtable 426 can assign a new label \tilde{S} 466. The system can take into account the temporal dependency of cluster labels, e.g., that if two timestamps are close in time, an assumption may be made that the data corresponding to the two temporally close timestamps belongs to the same cluster, and that if two timestamps are far apart in time, an assumption may be made that the data corresponding to the two far apart timestamps belongs to different clusters. That is, if data appears to switch between data for close, adjacent, proximal, or neighboring timestamps, the data corresponding to the switched data may belong to the data cluster for the same or proximally close in time other neighbors. For example, state interpolation module 428 can perform a K-Nearest Neighbor (KNN) interpolation within a window size W_{Label} 468 (which is provided by a user), to pick the most common cluster label for the nth sample between

$$n - \frac{{w}_{Label}}{2} and n + \frac{{w}_{Label}}{2} ,$$

to main detected states \tilde{Z}ₛₜₐₜₑ 470. This can ensure that the state labels have a strong temporal correlation and further be robust against noise. Finally, outlier detection module 430 can produce an outlier label \tilde{Y}ₒᵤₜₗᵢₑᵣ 472 by checking whether Xₙₒᵣₘ 462 is within inlier bounds θ_{bound} 458 for detected states \tilde{Z}ₛₜₐₜₑ 470.

### Exemplary Environment for Facilitating Automated Data Imputation

FIG. 5 depicts an exemplary environment 500 for facilitating automated data imputation, in accordance with an embodiment of the present application. Environment 500 can include: a device 512, an associated user 514, and an associated display 516; a device 520 and an associated database 522; a system 501 with multi-state sensors 504; and a device 518. Devices 512, 518, and 520 can communicate with each other via a network 502. Device 520 (and/or database 522) can store, obtain, manage, or access data obtained from sensors with multiple states, including raw data and data which has been processed by device 518 (e.g., by an autoimputer module or autoimputer system associated with device 518). Devices 512, 518, and 520 can be a server, a computing device, or any device which can perform the functions described herein. Device 512 can also be a client computing or user device, such as a computer, a laptop, a mobile computing device, a tablet, a smartphone, or other computing device which can be operated by user 514 and which can include the display 516.

System 501 can be an industrial system and sensors 504 can include industrial sensors, e.g., operating in an industrial setting with various equipment. Device 520 can obtain readings 506 from multi-state sensors 504 of system 501. Sensors 504 can include vibration sensors attached to equipment (not shown) of system 501, where the equipment can operate in multiple states, e.g., off, idle, and active, where a respective sensor can emit a distinctive vibration signal depending on its state. Device 520 can store readings 506 in database 522 as, e.g., raw data 508. As discussed above, raw data 508 (obtained from industrial multi-state sensors 504) may include null values, missing values, and outliers.

During operation, device 520 can transmit raw data to device 518, e.g., in response to a request raw data 524 communication received from device 518, or in response to a user-generated command 532 (from user 514 via device 512) to generate a model. Device 520 can return raw data 526. Device 518 can receive raw data 526 (as raw data 528) along with user command 532 to generate the model (as a command 534). Device 518 can perform the operations described above in relation to FIGS. 1, 2, and 4. Device 518 can generate a cluster model based on raw data (operation 536). Device 518 can replace missing values with first imputed data (operation 538). Device 518 can update the cluster model based on the (first) imputed data (operation 540). Device 518 can identify and mark/mask outliers with null values to obtain filtered data (operation 542). Device 518 can update the cluster model based on the filtered data (operation 544). Device 518 can replace the null values with second imputed data (operation 546). Device 518 can iterate through these operations (e.g., 540-546) until a predetermined threshold or stopping criteria has been met, e.g., when the result is a matrix with no null values, missing values, or outliers. Once the predetermined threshold or stopping criteria is met, device 518 can return final data as preprocessed data (operation 548). For example, device 518 can send preprocessed data 550 to device 520. Device 520 can receive preprocessed data 550 (as preprocessed data 554), and can store preprocessed data 554 in database 522 (e.g., as preprocessed data 510).

Device 518 can also send preprocessed data 550 and model 552 to device 512. Device 512 can receive preprocessed data 550 (as preprocessed data 558) and model 552 (as model 560), and can display on the screen of display 516 interactive elements 562 (which allow user 514 to, e.g., view the model and view the preprocessed data). Display 516 can also include interactive graphical user interface elements and a visual representation of each iteration of the model 564, which is generated as part of receiving model 560. User 514 can select an interactive element on display 516, which can correspond to, e.g.: viewing the cluster model in detail, as described above in relation to diagram 300 of FIG. 3A; viewing the feature data in detail, as described above in relation to table 330 of FIG. 3B; and requesting additional information to be displayed regarding any single iteration performed by device 518.

In some embodiments, user 514 can use an interactive element displayed on display 516 to locally modify the preprocessed data (e.g., by manually inserting or deleting data for one or more timestamps via device 512), and send a command 572 to regenerate the model with the modified data. Device 518 can receive command 572 (as a command 574) and can perform operations 536-548 as described above, using the modified data instead of the raw data as the initial data. Device 518 can subsequently return updated preprocessed data and an updated model back to device 512, for subsequent redisplay (e.g., updated display) on display 516.

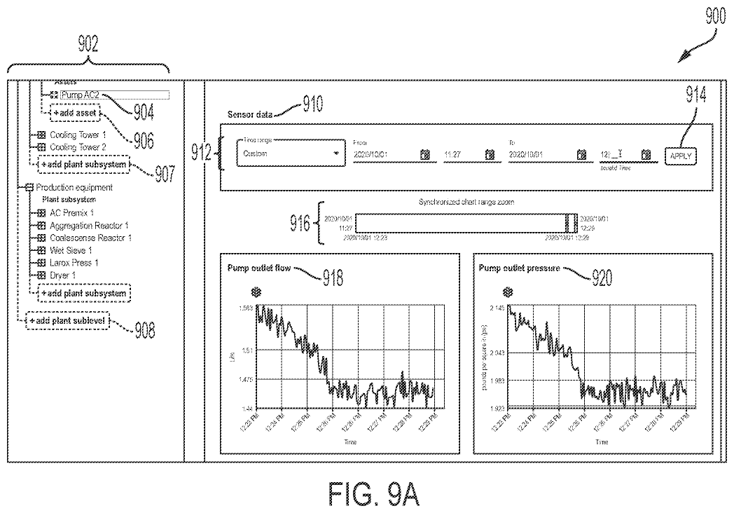

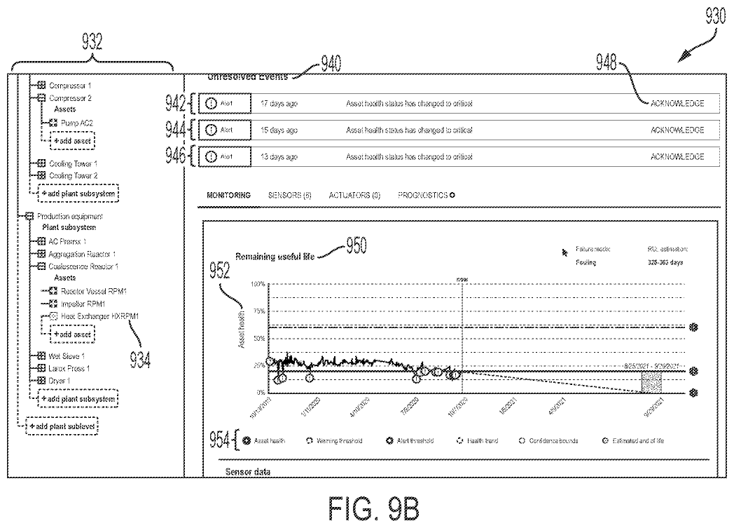

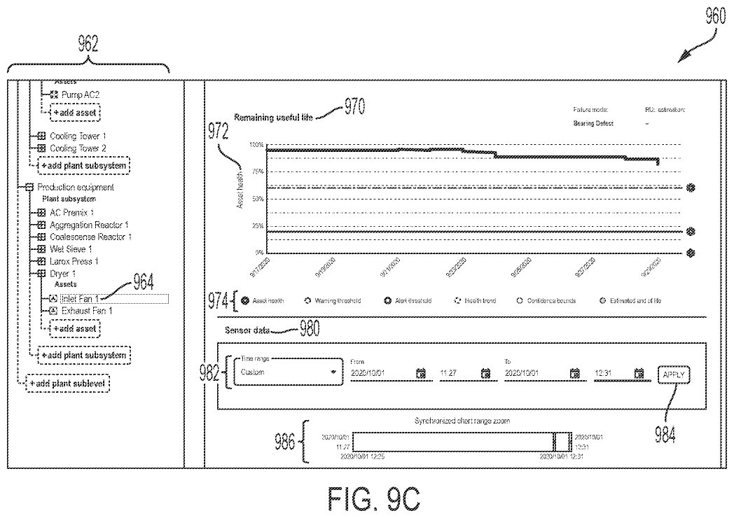

In some embodiments, user 514 can use an interactive element displayed on display 516 to create a model based on additional data, e.g., by adding a set of sensors for a plant sublevel, a plant subsystem, or an asset. FIGS. 9A-9C depict exemplary user interface screens that can be displayed on display 516 and manipulated or interacted on by user 512.

FIG. 9A illustrates an exemplary display screen 900 with interactive graphical user interface elements, in accordance with an embodiment of the present application. Screen 900 can include a navigation bar or index 902, a sensor data 910 section, and various diagrams 918 and 920. Index 902 can include a list assets grouped by plant subsystem and plant sublevel. User 512 can add a set of sensors for a particular asset, subsystem, or sublevel, by clicking, respectively, on elements 906, 907, and 908. Sensor data 910 can depict selectable widgets 912 which allow user 512 to select a time range as custom (or another pre-configured time range, such most recent cycle, day, week, month, etc., not shown), and an apply 914 element. Screen 900 can also include a synchronized chart range zoom 916, which can include, e.g., a slider which allows the user to zoom in on a portion of the selected time range. Screen 900 can display data related to multi-state sensors associated with the asset labeled as “Pump AC2” 902, including a pump outlet flow 918 diagram (which depicts a flow rate over a period of time) and a pump outlet pressure (which depicts pressure in pounds per square inch (“psi”) over a period of time).

FIG. 9B illustrates an exemplary display screen 930 with interactive graphical user interface elements, in accordance with an embodiment of the present application. Screen 930 can include a navigation bar or index 932, an unresolved events 914 section, and a remaining useful life 950 diagram. User 512 can select an asset, e.g., the asset labeled as “Heat Exchange HXRPM1” 934 and see unresolved events 940, which are include a visual indicator or alert that an event is still pending and needs to be resolved (e.g., by click on an element 948 to acknowledge the event). Remaining useful life 950 can depict an asset health 952 over time, and an index 954 can indicate information via markings (over time) for asset health, a warning threshold, an alert threshold, a health trend, confidence bounds, and an estimated end of life.

FIG. 9C illustrates an exemplary display screen 960 with interactive graphical user interface elements, in accordance with an embodiment of the present application. Screen 960 can include a navigation bar or index 962, a remaining useful life 970 diagram, and a sensor data 980 section. User 512 can select an asset, e.g., an asset labeled as “Inlet Fan 1” 964. User 512 can view information related to this asset. For example, a remaining useful life 970 can depict an asset health 972 over time and an index 954 can indicate information via markings (over time) for asset health, a warning threshold, an alert threshold, a health trend, confidence bounds, and an estimated end of life. Similar to diagram 900 of FIG. 9A, sensor data 980 can depict selectable widgets 982 which allow user 512 to select a time range as custom (or another pre-configured time range, such most recent cycle, day, week, month, etc., not shown), and an apply 984 element. Screen 900 can also include a synchronized chart range zoom 986, which can include, e.g., a slider which allows the user to zoom in on a portion of the selected time range.

Thus, environment 500 depicts exemplary entities and communications which facilitate automated data imputation. Environment 500 can also include user actions performed in response to device 518 performing the preprocessing of the data (i.e., automated data imputation), e.g., user 512 can use actionable and interactive graphical user interface elements on display 516 associated with device 512. User 512 can also manipulate an interface to modify the data which is preprocessed and used to construct the model, as described above in relation to the exemplary display screens of FIGS. 9A-9C.

### Exemplary Method for Facilitating Automated Data Imputation

FIG. 6 presents a flow chart illustrating a method for facilitating automated data imputation, in accordance with an embodiment of the present application. During operation, the system receives a request to process raw data obtained from sensors with multiple states, wherein the raw data include missing values (operation 602). The system generates a cluster model based on the raw data (operation 604). The system replaces the missing values with first imputed data based on the cluster model (operation 606). The system can resample data and replace the missing values, as described above in relation to FIGS. 3A, 3B, and 4. If a predetermined threshold has not been reached (decision 608), the system iterates through the following operations. The system updates the cluster model based on the most recently imputed data (operation 610). The most recently imputed data can be the “first imputed data” as determined by operations 602, 604, 606, and 608, or the most recently imputed data can be the “second imputed data” as determined by the iterations or feedback loop of operations 610-618 and 608. That is, subsequent to operation 606, the first imputed data is the “most recently imputed data,” as used in operation 610 in the initial iteration. The system predicts outliers based on the cluster model (operation 612). The system marks the outliers as null values to obtain filtered data (operation 614). The system updates the cluster model based on the filtered data (operation 616). The system replaces the null values with second imputed data based on the cluster model (operation 618), and the operation returns to decision 608. Subsequent to operation 618, the second imputed data is now the “most recently imputed data” as used in subsequent iterations including operation 610.

The system iterates through operations one or more or all of operations 610-618 until the predetermined threshold has been reached. If the predetermined threshold has been reached (decision 608), the system returns final data generated based on the cluster model (i.e., the current cluster model as most recently updated in the iterative rounds), and the operation returns.

FIG. 7A presents a flow chart illustrating a method for facilitating automated data imputation, in accordance with an embodiment of the present application. During operation, the system receives, by a cluster imputer module, input data which is raw data, wherein the raw data include missing values or null values (operation 702). The system generates, by the cluster imputer module, a cluster model based on the raw data (operation 704). The system generates, by the cluster imputer module, new samples (first imputed data) for the missing or null values (operation 706). The system replaces, by the cluster imputer module, the missing or null values with the first imputed data (operation 708). If a predetermined threshold has not been reached (decision 710), the system iterates through the operations beginning at Label A of FIG. 7B. If the predetermined threshold has been reached (decision 710), the system returns final data (e.g., preprocessed data) generated based on the cluster model. The final or preprocessed data can comprise a feature matrix with no missing values, no null values, and no outliers.

FIG. 7B presents a flow chart 720 illustrating a method for facilitating automated data imputation, in accordance with an embodiment of the present application. At Label A, the system receives, by an outlier remover module, the most recently imputed data (operation 722), depending on the iteration or round. That is, if the iteration is in the first round, the first imputed data is received and processed as the most recently imputed data, while if the iteration is in a subsequent round, the second imputed data is received and processed as the most recently imputed data.

The system updates, by the outlier remover module, the cluster model based on the most recently imputed data (operation 724) (e.g., the most recently imputed data can be the first or the second imputed data, depending on the iteration or round). The system identifies and predicts, by the outlier remover module, outliers based on the cluster model (operation 726). The system masks, by the outlier remover module, the outliers with null values to obtain filtered data (operation 728). The filtered data can include outlier-filtered null value-corrupted data. The outlier remover module can send to the cluster imputer module the filtered data, and the cluster imputer module can receive from the outlier remover module the filtered data (not shown).

The system updates, by the cluster imputer module, the cluster model based on the filtered data (operation 730). The system generates, by the cluster imputer module, new samples (second imputed data) for the missing or null values (operation 732). The system replaces, by the cluster imputer module, the null values with the second imputed data (operation 734), and the operation returns to decision 708 of FIG. 7A.

Note that in operations 704, 724, and 730 (i.e., the cluster imputer module generating the cluster model based on the raw data, the outlier remover module updating the cluster model based on the most recently imputed data, and the cluster imputer module updating the cluster model based on the filtered data), the system can perform operations as described above in relation to FIGS. 3 and 4. For example, in generating or updating the cluster model, the system can determine clusters and information associated with the cluster. The information can include one or more of: a number of clusters; a centroid of a respective cluster; and a standard deviation associated with the respective cluster. The system can classify a group of data points or cluster as an outlier cluster, and can also classify a point as an outlier cluster. The system can also determine whether an outlier point belongs to a first cluster of the determined clusters or to an outlier cluster.

### Exemplary Distributed Computer System

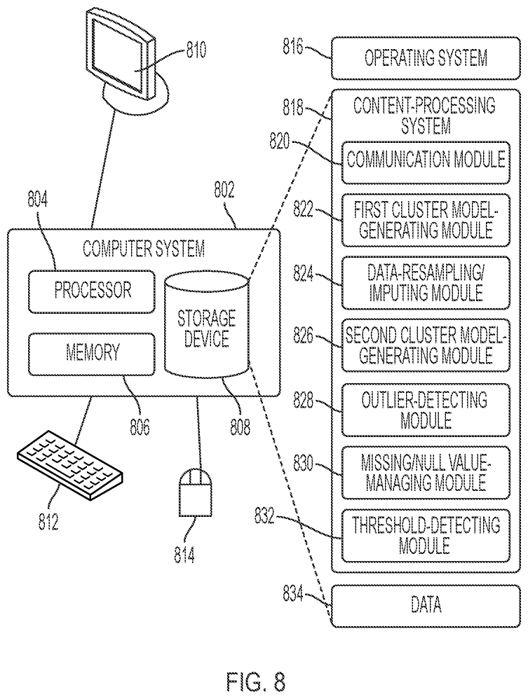

FIG. 8 illustrates an exemplary distributed computer and communication system that facilitates automated data imputation, in accordance with an embodiment of the present application. Computer system 802 includes a processor 804, a memory 806, and a storage device 808. Memory 806 can include a volatile memory (e.g., RAM) that serves as a managed memory, and can be used to store one or more memory pools. Furthermore, computer system 802 can be coupled to a display device 810, a keyboard 812, and a pointing device 814. Storage device 808 can store an operating system 816, a content-processing system 818, and data 834.

Content-processing system 818 can include instructions, which when executed by computer system 802, can cause computer system 802 to perform methods and/or processes described in this disclosure. Specifically, content-processing system 818 may include instructions for sending and/or receiving/obtaining data packets to/from other network nodes across a computer network (communication module 820). A data packet can include a request, data, raw data, imputed data, filtered data, a state, and a classification.

Content-processing system 818 can further include instructions for generating a cluster model based on raw data obtained from sensors with multiple states, wherein the raw data includes missing values (first cluster model-generating module 822). Content-processing system 818 can include instructions for replacing the missing values with first imputed data based on the cluster model (data-resampling/imputing module 824). Content-processing system 818 can include instructions for iterating, until a predetermined threshold has been reached (threshold-detecting module 832), through a series of operations which include the following operations. Content-processing system 818 can include instructions for: updating the cluster model based on most recently imputed data (second cluster model-generating module 826); predicting outliers based on the cluster model (outlier-detecting module 828); marking the outliers as null values to obtain filtered data (missing/null value-managing module 830); updating the cluster model based on the filtered data (first cluster model-generating module 822); and replacing the null values with second imputed data based on the cluster model (data-resampling/imputing module 824).

Data 834 can include any data that is required as input or that is generated as output by the methods and/or processes described in this disclosure. Specifically, data 834 can store at least: data; a command; a request; raw data; imputed data; most recently imputed data; filtered data; normalized or denormalized data; final data; preprocessed data; data with missing values or null values; a null value; a matrix; a model; a cluster model; a result of an iteration; a predetermined threshold; a stopping criteria; a number of rows; data associated with a sensor; data obtained from sensors with multiple states; an indicator of a sensor; a clustering algorithm; a MeanShift Clustering Algorithm; an outlier point; an outlier cluster; a cluster; a sample; a null value-free matrix; a number of clusters; a number of centroids; a standard deviation; a weight probability; a random variable; a mean; a confidence interval; a user-provided confidence interval; a density distribution; a parameter; a parameter tuple; a normalizer parameter; a hash table; a label; an outlier or inlier label; an inlier bound; a user-defined control parameter; and a state.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-executable method, comprising:
generating a cluster model based on raw data obtained from sensors with multiple states, wherein the raw data includes missing values;
replacing the missing values with first imputed data based on the cluster model; and
iterating, until a predetermined threshold has been reached, through a series of operations which include:
updating the cluster model based on most recently imputed data;
predicting outliers based on the cluster model;
marking the outliers as null values to obtain filtered data;
updating the cluster model based on the filtered data; and
replacing the null values with second imputed data based on the cluster model.

2. The method of claim 1, wherein prior to generating the cluster model based on the raw data, the method further comprises:
receiving a request to process the raw data, wherein a state of a sensor includes one or more of off, idle, and active;
subsequent to iterating through the series of operations until the predetermined threshold has been reached, returning final data generated based on the cluster model; and
storing, in a database, the final data as preprocessed data.

3. The method of claim 1,
wherein generating the cluster model based on the raw data, replacing the missing values with the first imputed data, updating the cluster model based on the filtered data, and replacing the null values with the second imputed data is performed by a first module, and
wherein updating the cluster model based on the most recently imputed data, predicting the outliers, and marking the outliers as null values is performed by a second module.

4. The method of claim 3, wherein iterating through the series of operations further involves the first module:
receiving, as input data, the raw data or the filtered data;
replacing the missing or null values with the most recently imputed data; and
transmitting, as output data, the most recently imputed data to the second module.

5. The method of claim 4, wherein iterating through the series of operations further involves the second module:
receiving, as input data, the most recently imputed data from the first module;
updating the cluster model based on the most recently imputed data;
predicting the outliers based on the cluster model;
removing the outliers by marking the outliers as null values to obtain the filtered data; and
transmitting, as output data, the filtered data to the first module.

6. The method of claim 1,
wherein the first module includes a first cluster outlier module, a resampler module, and a denormalizer module, and
wherein the second module includes a second cluster outlier module and a null value imputer module.

7. The method of claim 1, wherein generating the cluster model based on the raw data and updating the cluster model based on the most recently imputed data or the filtered data comprises one or more of:
determining, based on the raw data, the most recently imputed data, or the filtered data, clusters and information associated with the clusters,
wherein the information associated with the clusters includes one or more of: a number of clusters; a centroid of a respective cluster; and a standard deviation associated with the respective cluster;
classifying a cluster as an outlier cluster;
classifying a point as an outlier point; and
determining that the outlier point belongs to a first cluster of the determined clusters.

8. The method of claim 7, wherein replacing the missing values with the first imputed data and replacing the null values with the second imputed data comprises:
generating, for a missing or null value based on a Gaussian distribution, a sample based on the determined clusters and the information associated with the clusters; and
replacing the missing or null value with the generated sample.

9. The method of claim 1,
wherein the cluster model is generated or updated based on a Gaussian Mixture Model with a number of centroids,
wherein a probability density function of the GMM is based on a Gaussian distribution,
wherein an outlier cluster is defined based on a user-defined threshold, and
wherein an outlier point is defined based on a user-defined confidence level.

10. A computer system for facilitating data classification, the computer system comprising:
a processor; and
a storage device storing instructions that when executed by the processor cause the processor to perform a method, the method comprising:
generating a cluster model based on raw data obtained from sensors with multiple states, wherein the raw data includes missing values;
replacing the missing values with first imputed data based on the cluster model; and
iterating, until a predetermined threshold has been reached, through a series of operations which include:
updating the cluster model based on most recently imputed data;
predicting outliers based on the cluster model;
marking the outliers as null values to obtain filtered data;
updating the cluster model based on the filtered data; and
replacing the null values with second imputed data based on the cluster model.

11. The computer system of claim 10, wherein prior to generating the cluster model based on the raw data, the method further comprises:
receiving a request to process the raw data, wherein a state of a sensor includes one or more of off, idle, and active;
subsequent to iterating through the series of operations until the predetermined threshold has been reached, returning final data generated based on the cluster model; and
storing, in a database, the final data as preprocessed data.

12. The computer system of claim 10,
wherein generating the cluster model based on the raw data, replacing the missing values with the first imputed data, updating the cluster model based on the filtered data, and replacing the null values with the second imputed data is performed by a first module, and
wherein updating the cluster model based on the most recently imputed data, predicting the outliers, and marking the outliers as null values is performed by a second module.

13. The computer system of claim 12, wherein iterating through the series of operations further involves the first module:
receiving, as input data, the raw data or the filtered data;
replacing the missing or null values with the most recently imputed data; and
transmitting, as output data, the most recently imputed data to the second module.

14. The computer system of claim 13, wherein iterating through the series of operations further involves the second module:
receiving, as input data, the most recently imputed data from the first module;
updating the cluster model based on the most recently imputed data;
predicting the outliers based on the cluster model;
removing the outliers by marking the outliers as null values to obtain the filtered data; and
transmitting, as output data, the filtered data to the first module.

15. The computer system of claim 10,
wherein the first module includes a first cluster outlier module, a resampler module, and a denormalizer module, and
wherein the second module includes a second cluster outlier module and a null value imputer module.

16. The computer system of claim 10, wherein generating the cluster model based on the raw data and updating the cluster model based on the most recently imputed data or the filtered data comprises one or more of:
determining, based on the raw data, the most recently imputed data, or the filtered data, clusters and information associated with the clusters,
wherein the information associated with the clusters includes one or more of: a number of clusters; a centroid of a respective cluster; and a standard deviation associated with the respective cluster;
classifying a cluster as an outlier cluster;
classifying a point as an outlier point; and
determining that the outlier point belongs to a first cluster of the determined clusters.

17. The computer system of claim 16, wherein replacing the missing values with the first imputed data and replacing the null values with the second imputed data comprises:
generating, for a missing or null value based on a Gaussian distribution, a sample based on the determined clusters and the information associated with the clusters; and
replacing the missing or null value with the generated sample.

18. The computer system of claim 10,
wherein the cluster model is generated or updated based on a Gaussian Mixture Model with a number of centroids,
wherein a probability density function of the GMM is based on a Gaussian distribution,
wherein an outlier cluster is defined based on a user-defined threshold, and
wherein an outlier point is defined based on a user-defined confidence level.

19. A non-transitory computer-readable storage medium storing instructions that when executed by a computer cause the computer to perform a method, the method comprising:
generating a cluster model based on raw data obtained from sensors with multiple states, wherein the raw data includes missing values;
replacing the missing values with first imputed data based on the cluster model; and
iterating, until a predetermined threshold has been reached, through a series of operations which include:
updating the cluster model based on most recently imputed data;
predicting outliers based on the cluster model;
marking the outliers as null values to obtain filtered data;
updating the cluster model based on the filtered data; and
replacing the null values with second imputed data based on the cluster model.

20. The non-transitory computer-readable storage medium of claim 19,
wherein generating the cluster model based on the raw data and updating the cluster model based on the most recently imputed data or the filtered data comprises one or more of:
determining, based on the raw data, the most recently imputed data, or the filtered data, clusters and information associated with the clusters,
wherein the information associated with the clusters includes one or more of: a number of clusters; a centroid of a respective cluster; and a standard deviation associated with the respective cluster;
classifying a cluster as an outlier cluster;
classifying a point as an outlier point; and
determining that the outlier point belongs to a first cluster of the determined clusters; and
wherein replacing the missing values with the first imputed data and replacing the null values with the second imputed data comprises:
generating, for a missing or null value based on a Gaussian distribution, a sample based on the determined clusters and the information associated with the clusters; and
replacing the missing or null value with the generated sample.
